(19) United States
(12) Patent Application Publication
(10) Pub. No.: US 2004/0004205 A1
(43) Pub. Date: Jan. 8, 2004

(54) Valve stem and gasket apparatus and method

(75) Inventor: Russell F. Kuzniar, Elkhorn, WI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: United Dominion Industries, Inc.

(21) Appl. No.: 10/188,034

(22) Filed: Jul. 3, 2002

(51) Int. Cl. F02N 3/00; F16K 1/00

(52) U.S. Cl. 251/357; 123/188.3

(57) ABSTRACT

A valve stem and gasket apparatus and method includes a gasket that may be made of PEEK. A tool block set can be used to install the gasket over a flange on the stem.

### FIELD OF THE INVENTION

The invention relates to valve assemblies and methods, and in particular to sanitary valve assemblies used in food industries and elsewhere. The invention can be useful where it is desirable to periodically clean the valve assembly.

### BACKGROUND OF THE INVENTION

The present invention is directed generally to valve assemblies and methods, and more particularly can be useful as a valve assembly and method in the class of valves used in high pressure high flow applications, such as those in food processing industries where cleanability of equipment is important.

One prior art valve assembly is disclosed in U.S. Pat. No. 4,948,096, issued Aug. 14, 1990, entitled “Valve Stem And Gasket With Improved Cleanability,” the disclosure of which is incorporated herein by reference. This patent discloses a valve assembly that includes a sealing ring gasket trapped between spaced apart flanges of a valve stem. The outer flange is smaller than the inner flange. The gasket is installed by being worked over the smaller, outer flange, causing one end of the gasket to deflect with the cross section undergoing rolling motion. Upon passing over the outer flange, the deflected end of the gasket resumes its normal size, thereby remaining captive between the two spaced apart valve stem flanges. The outer valve stem flange and the gasket have recesses formed therein for visual inspection of hidden surfaces, useful to evaluate flush cleaning performed on the valve assembly. The gasket internal bore and the valve stem body extending between the flanges have generally complimentary cross section configurations. The gasket has a tapered bore to aid insertion on the valve stem and the recesses are part conical, terminating at an intermediate point along the gasket bore. The gasket is dimensioned to float in radial and axial dimensions when mounted on the valve stem. This patent discloses a preferred embodiment in which the gasket is made of PTFE.

One of the many benefits of the arrangement disclosed in U.S. Pat. No. 4,948,096 is that the sealing ring can be snapped onto the valve stem at room temperature. Another advantage of this structure is that the floating ability of the gasket on the valve stem permits at least some degree of visual inspection in the clearance between the gasket and the valve stem once the gasket is installed. The floating ability can also provide the benefit of facilitating cleaning fluid movement in the clearance, so that cleaning fluid can dislodge trapped particles and/or materials. Further, the floating arrangement and can also provide for convenient visual inspection of at least part of the clearance areas between the gasket and the valve stem.

One limitation of the use of PTFE for a gasket of this type is that the PTFE material often does not perform satisfactorily in applications where temperatures exceed 180 degrees F., because the PTFE material tends to soften and/or melt above that temperature.

Accordingly, there is a need in the art for an apparatus and method that can provide the ability to operate above 180 degrees F., and that may also may also provide the ability to snap a gasket ring that can operate above 180 degrees F., onto a valve stem at room temperature, and that can further provide a clearance for cleaning fluid and visual inspection between the gasket and valve stem. It would also be desirable to have such an apparatus and method that can provide desirable sealing action.

### SUMMARY OF THE INVENTION

It is therefore a feature and advantage of the present invention to provide a gasket having the ability to operate above 180 degrees F. It is another feature and advantage to provide the ability to snap a gasket ring, including one that can operate above 180 degrees F., onto a valve stem at room temperature. Further features and advantages of some embodiments include being able to provide a clearance for cleaning fluid and visual inspection between the gasket and valve stem, and provide desirable sealing action.

The above and other features and advantages are achieved through the use of a novel valve stem and gasket apparatus and method as herein disclosed. In accordance with one embodiment of the present invention, a valve stem and gasket assembly includes a valve stem having a body and having an inner end for connection to an actuator and an opposed outer end. A first, smaller flange is carried on the body adjacent the outer end and a spaced apart second, outer flange is also carried on the body between the first flange and the body inner end. An annular gasket is carried on the body, disposed between the first and second flanges, and is compromised at least partially of a ketone polymer material.

In accordance with another embodiment of the present invention, a sealing apparatus for use installed on a valve stem assembly has an annular gasket comprised at least partially of ketone polymer material.

In accordance with another embodiment, a valve stem and gasket assembly has a valve stem having a body and having an inner end for connection to an actuator and an opposed outer end. Sealing means is carried on the body, and is comprised at least partially of a ketone polymer material. Retaining means is provided for retaining the sealing means on the body.

In accordance with another embodiment, a method of installing an annular gasket on a valve stem is provided. A valve stem is supported on a stem receiving surface of a first tool block. An annular gasket is used over a flange of the valve stem by applying pressure to the annular gasket with a gasket receiving surface of a second tool block. The valve stem is removed with the sealing ring installed thereon from the first tool block.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a sealing ring mounted on a valve stem according to a preferred embodiment of the invention.

FIG. 2 is a side elevational view of the valve assembly of FIG. 1.

FIG. 3 is an end elevational view of the valve assembly of FIG. 1.

FIG. 4 is a layout view of a valve stem and two installation tools prior to installation of the sealing ring.

FIG. 5 illustrates a first step in the installation of a sealing ring.

FIG. 6 illustrates a second step in the installation of a sealing ring.

FIG. 7 is a detail view of the detail labeled 7 in FIG. 6.

FIG. 8 illustrates a third step in the installation of a sealing ring.

FIG. 9 illustrates the removal from the installation tools of a valve stem having an installed sealing ring.

### DETAILED DESCRIPTION OF PREFERRED EMBODIMENTS OF THE INVENTION

The present invention relates in one aspect to a novel valve stem and sealing ring gasket apparatus and method that preferably in some embodiments utilizes PEEK material in the sealing ring. The invention also pertains in another aspect to a novel method and apparatus for installing a sealing ring onto a valve stem.

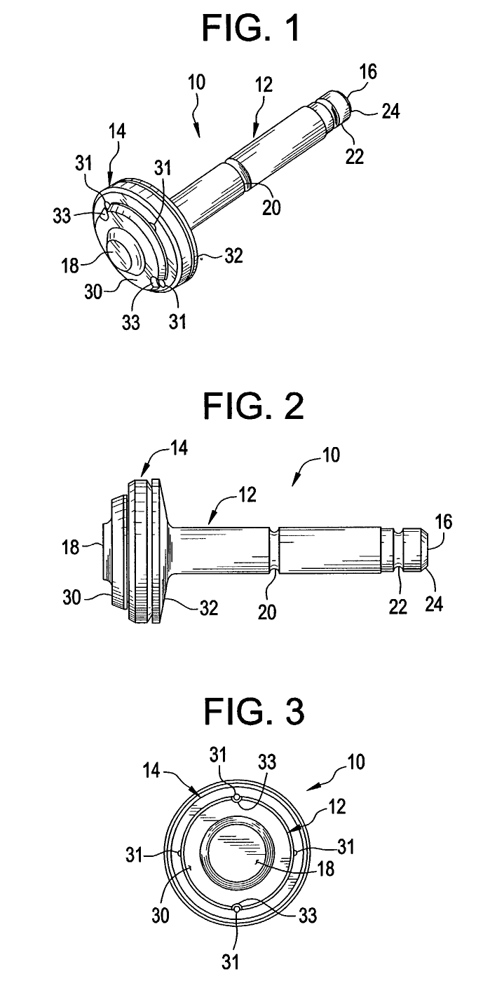

Turning now to FIGS. 1-3, a valve assembly is generally indicated as 10, and includes a valve stem generally indicated as 12 and a gasket generally indicated as 14. In a preferred embodiment, the valve stem 12 has an inner free end 16 and an opposed outer free end 18.

In some embodiments, a recess 20 can be provided for mounting the valve stem to a linear actuator which drives the valve stem in an axial direction with the outer end 18 thereof leading during a valve closing operation. The recess 20 is optional and provides for seating of an O-ring gasket where desired.

The valve stem 12 can also further include a chamfered edge 24 and a recess 22 at the valve stem inner end 16 to provide a quick connect mounting of the valve stem to a linear actuator. If some preferred embodiments, other conventional means, such as screw threads, may be employed to mount the valve stem 12 to a suitable actuator.

The stem 12 in FIGS. 1-3 of the present application is similar to the stem 12 shown in FIGS. 1-3 of U.S. Pat. No. 4,948,096 issued on Aug. 14, 1990 and entitled “Valve Stem And Gasket With Improved Cleaning Capability”, the disclosure of which is hereby incorporated by reference. FIGS. 1-3 of the present application illustrate the valve stem 12 having an first, outer flange 30 located approximately at the outer end 18 and a second, inner flange 32 axially spaced therefrom, being positioned remote from the outer end 18. With reference to FIG. 2, for example, it can be seen that the outer flange 30 has a reduced diameter compared to the inner flange 32. The stem 12 and gasket 14 are preferably be shaped and dimensioned generally as described in the U.S. Pat. No. 4,948,096.

Accordingly, in certain preferred embodiments of the invention, a valve stem 12 is provided that can be shaped substantially similar to the valve stem 12 described in the U.S. Pat. No. 4,948,096. Further, a gasket ring 14 is provided which may be shaped substantially the same as the gasket described in the U.S. Pat. No. 4,948,096 patent, although sometimes preferably without the recesses 31 as discussed in more detail below.

The gasket ring 14 in some embodiments of the invention is preferably made at least partially or wholly from PEEK material. As used herein, “PEEK” refers to ketone polymer materials known as e.g., polyaryletherketones, including the materials known in the trade as PAEK, PEK, PEEK, and or PEKK. As used herein, PEEK refers to all materials in the family of these ketone polymers. An example of these materials is the material sold under the brand name PEEK™ available from Victrex PLC.

A significant benefit of the use PEEK material as the sealing ring material for ring 14 is that is continues to perform at elevated temperatures beyond which the prior art PTFE sealing rings would perform. For example, PEEK sealing rings have been found to perform at temperatures exceeding 180 degrees F., including temperatures up to 280 degrees F. Thus, the use of PEEK in the sealing ring 14 of certain embodiments of the present invention provides an ability to operate at higher temperatures than the prior art PTFE sealing ring arrangement. Further, the use of PEEK permits the same valve stem 12 configuration to be used interchangeably with either PTFE or PEEK sealing rings.

In general, another benefit of utilization of PEEK is that the PEEK sealing ring 14 can be snapped in place over the outer flange by using a press fit technique at room temperature. This is desirable because it avoids the need to heat the sealing ring or other components during sealing ring installation.

FIGS. 1-3 illustrate four opposed notches 31 provided in the outer flange 30. These notches or recesses 31 are preferably used with the preferred embodiment, but are optional. The notches or recesses 31 provide enhanced fluid flow into the clearance between the gasket 14 and stem 12 during cleaning processes, and also provide for enhanced visual inspection as to whether material remains trapped in the clearance.

FIGS. 1-3 also depict two notches 33 in the sealing ring 14 itself. The sealing ring 14 of the present invention may be provided with these notches 33 in some embodiments to further aid in cleaning fluid flow into the clearance and visual inspection. However, in some embodiments (such as many embodiments when PEEK is used as a gasket ring material) where the provision of notches would cause undesirable stress failures at those locations, it has been found preferable to omit the notches 33.

In the preferred embodiments, the valve stem 12 may preferably be manufactured from stainless steel, although it may be manufactured from other metals, alloys or other materials.

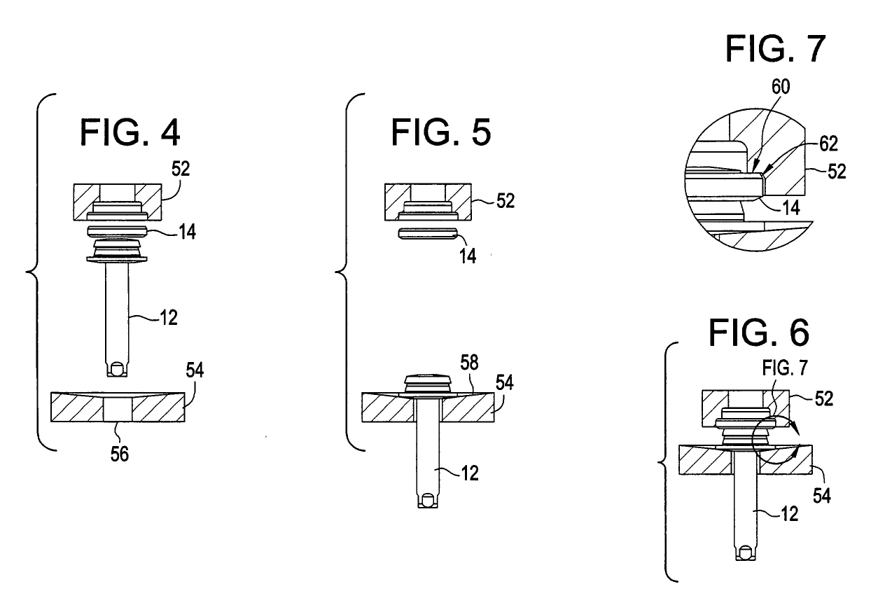

FIGS. 4-9 depict another aspect of the invention which provides for installation of the sealing ring 14 on the valve stem 12. Specifically, FIGS. 4-9 illustrate the use of a pair of installation tools 52 and 54, which may be manufactured from a suitable inexpensive material such as HDPE plastic. It is preferable that at least the ring tool 52 have relatively soft surfaces where it contacts the sealing ring 14 so that the ring tool 52 does not put a damaging stress on the ring 14.

In FIG. 4, a base tool 54 is first placed on a table surface with its central bore 56 aligned with a hole in the table. The ring tool 52, stem 12 and sealing ring 14 are also shown.

Next, in FIG. 5, a valve stem 12 is inserted through the hole 56 in the base tool 54 so that the valve stem 12 rests on the base tool 54 as illustrated. The base tool 54 has a conical concavity 58 on the surface facing the bottom of the flange 32. The conical surface 58 shapes towards the central hole 56 and the hole 56 is dimensioned to be larger than the diameter of the shaft of the stem 12. This allows the inner flange 32 to rest on the conical surface 58 without any interference of the radiusing that joins the inner flange 32 to the shaft of the stem 12.

Next, in FIG. 6 the sealing ring 14 is pressed over the outer flange 30 by application of pressure to the sealing ring tool 52 that receives pressure on its top surface and presses down onto the top flat side of the sealing ring 14 to press on the ring 14 so that the ring 14 expands over the outer flange 30 and snaps fully over the outer flange 30 and into place between the flanges 30 and 32. In a preferred embodiment, the base ring tool 52 rests on the table, and pressure is applied to the top side of the seat ring tool 54 using an arbor press or similar mechanical device. In some embodiments, manual pressure may be sufficient.

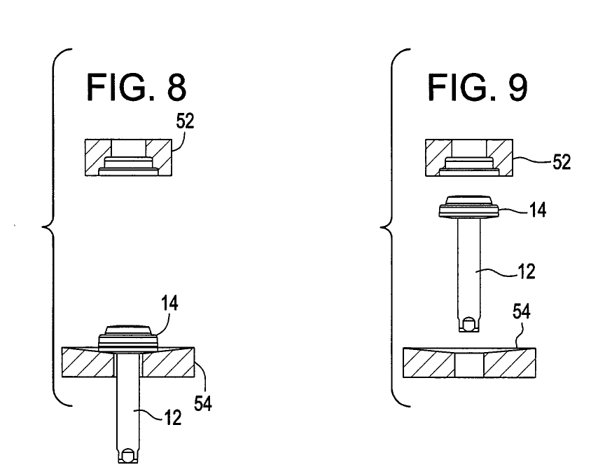

FIG. 7 shows the contact between the tool 52 and ring 14 in greater detail. The tool 52 has a flat circular area 60 that pushes against the top of the ring 14. A clearance 62 is provided around the circumference of the ring 14 to permit the ring to expand. The operation of FIG. 6 results in the configuration shown in FIG. 8. FIG. 9 shows the stem 12, with the sealing ring 14 installed, being removed from the tools 52 and 54.

The use of the tools 52, 54 described herein is particularly beneficial for installing PEEK sealing rings, because PEEK sealing rings can be more brittle than PTFE rings, and the use of tools 52, 54 provides an effective method and apparatus for installing the sealing rings without damaging them. This is due at least in part to the shape of the tools and/or to the tools being of a softer material than the sealing ring. Another benefit of the tools 52, 54 is that the tools 52, 54 can also be used to install a PTFE ring or rings of other materials as well.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A valve stem and gasket assembly, comprising:
a valve stem having a body and having an inner end for connection to an actuator and an opposed outer end;
a first, smaller flange carried on said body adjacent the outer end and a spaced apart second, larger flange also carried on said body between said first flange and said body inner end; and
an annular gasket carried on said body, disposed between said first and second flanges, said gasket compromised at least partially of a ketone polymer material.

2. The apparatus according to claim 1, wherein said gasket is made completely of a ketone polymer material.

3. The apparatus according to claim 1, wherein the material is at least one of PEEK, PAEK, PEK, and PEKK.

4. The apparatus according to claim 2, wherein the material is at least one of PEEK, PAEK, PEK, and PEKK.

5. A sealing apparatus for use installed on a valve stem assembly, comprising:
an annular gasket comprised at least partially of ketone polymer material.

6. The apparatus according to claim 5, wherein said gasket ring is made completely of a ketone polymer material.

7. The apparatus according to claim 5, wherein the material is at least one of PEEK, PAEK, PEK, and PEKK.

8. The apparatus according to claim 6, wherein the material is at least one of PEEK, PAEK, PEK, and PEKK.

9. A valve stem and gasket assembly, comprising:
a valve stem having a body and having an inner end for connection to an actuator and an opposed outer end;
sealing means carried on said body, and comprised at least partially of a ketone polymer material; and
retaining means for retaining said sealing means on said body.

10. The apparatus according to claim 9, wherein said gasket is made completely of a ketone polymer material.

11. The apparatus according to claim 9, wherein the material is at least one of PEEK, PAEK, PEK, and PEKK.

12. The apparatus according to claim 10, wherein the material is at least one of PEEK, PAEK, PEK, and PEKK.

13. An apparatus for installing an annular gasket onto a valve stem, the apparatus comprising:
a first tool block having a bore therethrough and a stem receiving surface; and
a second tool block having a gasket receiving surface.

14. An apparatus according to claim 13, wherein the annular ring is of a first material and at least one of the second tool block and the first tool block are of a first material softer than a second material of the annular ring.

15. An apparatus according to claim 13, wherein said first tool block and said second tool block are each at least partially comprised of HDPE plastic.

16. The apparatus according to claim 13, wherein said stem receiving surface of said first tool block comprises a conical surface and a bore extending through said first tool block.

17. An apparatus according to claim 13, wherein said gasket receiving surface of the second tool block comprises a circular indentation having a surface that contacts the gasket.

18. A method of installing an annular gasket on a valve stem, comprising the steps of:
supporting the valve stem on a stem receiving surface of a first tool block;
urging the annular gasket over a flange of the valve stem by applying pressure to the annular gasket with a gasket receiving surface of a second tool block; and
removing the valve stem with the sealing ring installed thereon from the first tool block.

19. The method of claim 18, wherein the urging step includes applying a force to the second tool block manually.

20. A method according to claim 18, wherein the urging step includes applying a force to the second tool block with a power-operated mechanical device.

21. A method according to claim 18, wherein the urging step includes step of providing the annular gasket, wherein the gasket is comprised at least partially of a ketone polymer material.

22. A method according to claim 21, wherein the gasket is made completely of a ketone polymer material.

23. A method according to claim 21, wherein the material is at least one of PEEK, PAEK, PEK and PEKK.

24. A method according to claim 22, wherein the material is at least one of PEEK, PAEK, PEK and PEKK.
